(19) United States
(12) Patent Application Publication
(10) Pub. No.: US 2024/0123719 A1
(43) Pub. Date: Apr. 18, 2024

(54) WEAR LAYER AND RELATED METHODS OF USE AND MANUFACTURE

(71) Applicant: KLÖCKNER PENTAPLAST OF AMERICA, INC., Gordonsville, VA (US)

(72) Inventors: Helmut Schupfner, Teising (DE); Andreas Schwägerl, Taching am See (DE); Mario Neumaier, Unterneukirchen (DE); Sascha Jürgens, Eppenrod (DE)

(21) Appl. No.: 18/480,226

(22) Filed: Oct. 3, 2023

Related U.S. Application Data
(60) Provisional application No. 63/416,188, filed on Oct. 14, 2022.

(51) Int. Cl. B32B 27/30; B32B 27/08; B32B 27/20; B32B 37/22; B32B 38/18

(52) U.S. Cl. CPC B32B 27/304; B32B 27/08; B32B 27/20; B32B 37/223; B32B 38/18; B32B 2307/412; B32B 2307/51; B32B 2307/536

(57) ABSTRACT

In various examples, the subject matter of this disclosure relates to a wear layer for flooring applications and related methods of manufacture. The wear layer can include a PVC resin and a stabilizer comprising CaZn mixed with the PVC resin. The wear layer can have a Shore D hardness of at least about 72 and/or a modulus of elasticity of at least about 1600 MPa. The wear layer can be characterized by an absence of plasticizer (e.g., adipates, phthalates (e.g., diisononyl phthalate or DINP), terephthalates (e.g., dioctyl terephthalate or DOTP), or 1,2-Cyclohexane dicarboxylic acid diisononyl ester (DINCH)) and tin-based stabilizer.

### CROSS-REFERENCE TO RELATED APPLICATIONS

This application claims the benefit of U.S. Provisional Patent Application No. 63/416,188, filed Oct. 14, 2022, entitled “Wear Layer and Related Methods of Use and Manufacture,” the entire contents of which are incorporated by reference herein.

### BACKGROUND

In general, the subject matter of this disclosure relates to composite building materials and, in certain examples, to luxury vinyl tile (LVT) and stone plastic composites (SPCs). LVT has gained immense popularity in the flooring industry due to its water resistance, aesthetic appeal, and easy installation. Likewise, SPC flooring, known for its resemblance to natural stone and exceptional durability, has seen substantial adoption. LVT and SPC flooring can come in a variety of sizes and shapes, including planks or tiles, and can have multiple layers, including a rigid core or backing layer, a print layer, and a wear layer. Both LVT and SPC flooring have their unique advantages, yet there is a need for LVT and SPC materials that are more durable and less harmful to health and the environment.

### SUMMARY

In general, the subject matter of this disclosure relates to a wear layer for use in composite building materials, such as LVT or SPC materials. In one example, a wear layer includes a mixture of a rigid polyvinyl chloride (PVC) and a CaZn stabilizer. The wear layer can have a Shore D hardness of at least about 72 and/or a modulus of elasticity of at least about 1600 MPa.

The wear layer described herein has several advantages over previous wear layers. For example, unlike previous flexible or semi-rigid wear layers, the wear layer described herein can be rigid and able to resist certain deformations or distortions that can appear in the previous wear layers. For example, when a flexible wear layer in an LVT is installed over a subfloor having imperfections (e.g., ridges or gaps), the imperfections can cause the wear layer to deform, such that the imperfections can become visible in the LVT over time. Further, compared to previous wear layers, the wear layer described herein can be free of plasticizers (e.g., adipates, phthalates (e.g., diisononyl phthalate or DINP), terephthalates (e.g., dioctyl terephthalate or DOTP), or 1,2-Cyclohexane dicarboxylic acid diisononyl ester (DINCH)) and/or certain stabilizers (e.g., tin-based stabilizers) that can be harmful to health and/or the environment. The wear layer can be fully compliant with strict environmental regulations, such as RoHS (Restriction of Hazardous Substances) and REACH (Registration, Evaluation, Authorisation and Restriction of Chemicals) in the European Union.

In one aspect, the subject matter of this disclosure relates to a wear layer. The wear layer incudes: a PVC resin; and a stabilizer including CaZn mixed with the PVC resin, wherein the wear layer has a Shore D hardness of at least about 72 and/or a modulus of elasticity of at least about 1600 MPa.

In certain examples, the PVC resin can include a blend of: a first PVC resin produced by mass polymerization (M-PVC) and/or a second PVC resin produced by suspension polymerization (S-PVC); and a third PVC resin produced by emulsion polymerization (E-PVC). The PVC resin can further include a PVC copolymer. The wear layer can be characterized by an absence of plasticizer. The stabilizer can be characterized by an absence of tin (Sn). The stabilizer can be characterized by an absence of barium (Ba). The PVC resin and the stabilizer can be mixed with an impact modifier, an internal lubricant, an external lubricant, a processing aid, a co-stabilizer including epoxidized soybean oil (ESO) and/or phosphite, or any combination thereof. The wear layer can be transparent. The wear layer can be configured for use in a luxury vinyl tile or a stone plastic composite.

In another aspect, the subject matter of this disclosure relates to a composite building material. The composite building material includes: a wear layer including: a PVC resin; and a stabilizer including CaZn mixed with the PVC resin, wherein the wear layer has a Shore D hardness of at least about 72 and/or a modulus of elasticity of at least about 1600 MPa. The composite building material can be or include a luxury vinyl tile or a stone plastic composite.

In another aspect, the subject matter of this disclosure relates to a method of manufacturing a wear layer. The method includes: providing a mixture of a PVC resin and a stabilizer including CaZn; and forming the mixture into a web, wherein the wear layer has a Shore D hardness of at least about 72 and/or a modulus of elasticity of at least about 1600 MPa.

In certain examples, forming the mixture into the web includes: melting the mixture; and applying the mixture to a plurality of calender rollers. The method can include winding the web into a roll.

In another aspect, the subject matter of this disclosure relates to a method of manufacturing a composite building material. The method includes: providing a wear layer including: a PVC resin; and a stabilizer including CaZn mixed with the PVC resin, wherein the wear layer has a Shore D hardness of at least about 72 and/or a modulus of elasticity of at least about 1600 MPa; and bonding the wear layer to at least one other layer.

In some examples, bonding the wear layer to the at least one other layer includes laminating the wear layer onto a printed layer. The composite building material can be or include a luxury vinyl tile and/or a stone plastic composite.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic, perspective view of a composite building material containing a wear layer, in accordance with certain examples; and

FIG. 2 is a schematic diagram of a process for manufacturing a wear layer, in accordance with certain examples.

### DETAILED DESCRIPTION

It is contemplated that apparatus, compositions, systems, and methods of the claimed invention encompass variations and adaptations developed using information from the embodiments described herein. Adaptation and/or modification of the apparatus, compositions, systems, and methods described herein may be performed by those of ordinary skill in the relevant art.

It should be understood that the order of steps or order for performing certain actions is immaterial so long as the invention remains operable. Moreover, two or more steps or actions may be conducted simultaneously.

In various examples, the compositions described herein may not include, or may be characterized by an absence of, an ingredient, such as a plasticizer or a tin-based stabilizer. In such instances, the composition may have none of the ingredient or may have only a trace amount of the ingredient (e.g., less than about 0.00015 wt % (percent by weight) of the ingredient).

In general, the subject matter of this disclosure relates to a wear layer that can be incorporated into composite building materials, such as luxury vinyl tile (LVT), stone plastic composite (SPC), laminated flooring products, or similar materials, for use in residential, commercial, and/or industrial applications. The wear layer can be bonded or laminated to one or more other layers in a composite building material and can protect the other layer(s) from wear and tear caused by, for example, mechanical abrasion or impact.

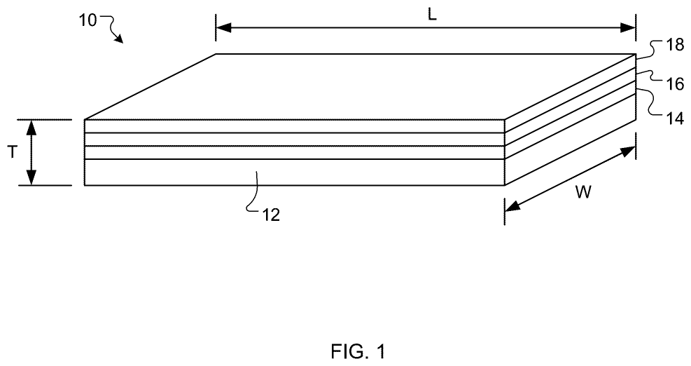

Referring to FIG. 1, in some examples, a composite building material 10 can include a backing layer 12, a printed layer 14 disposed on and bonded to the backing layer 12, a wear layer 16 disposed on and bonded to the printed layer 14, and a surface layer or coating 18 disposed on and bonded to the wear layer 16. The backing layer 12 can provide desired flatness characteristics as well as dimensional stability to the composite building material 10. The printed layer 14 can be or include a thin, printed material (e.g., paper) having a color pattern, such as an image of wood, ceramic, or stone. The wear layer 16 can protect the printed layer 14 from damage caused by, for example, wear and tear (e.g., mechanical abrasion), ultraviolet radiation, moisture, solvents, etc. In some examples, the wear layer 16 can have a texture or embossing that complements the color pattern in the printed layer 14. The surface layer 18 can be or include a protective coating such as, for example, a polyurethane coating and/or an ultraviolet curable (UV) coating. The surface layer 18 can protect the composite building material 10 and/or can provide a desired sheen (e.g., gloss or matte). In certain examples, the wear layer 16 and the surface layer 18 are transparent (e.g., clear) such that the color pattern on the printed layer 14 can be visible through a top surface of the composite building material 10.

In various examples, the composite building material 10 can be used to cover a subfloor material (e.g., plywood or concrete) to achieve a finished floor having a look of natural wood, ceramic, stone, or other material. For example, multiple planks or tiles of the composite building material 10 can be arranged side-by-side over the subfloor and can have interlocking edges (e.g., on the backing layer 12).

The composite building material 10 can be provided in a variety of shapes and sizes, including rectangular planks or square tiles. A thickness T of the composite building material 10 can be, for example, from about 2 mm to about 8 mm, or about 3 mm. The wear layer 16 can have a thickness from about 0.1 mm to about 1 mm, or from about 0.3 mm to about 0.7 mm.

In certain examples, the wear layer 16 can be or include a polyvinyl chloride (PVC) composition. The PVC composition can include one or more types of PVC, including, for example, a first PVC resin produced by mass polymerization (M-PVC), a second PVC resin produced by suspension polymerization (S-PVC), a third PVC resin produced by emulsion polymerization (E-PVC), a PVC copolymer, or any combination thereof. The M-PVC, S-PVC, and E-PVC can be or include homopolymers produced from vinyl chloride monomers. The M-PVC, S-PVC, and/or E-PVC can have a K value (e.g., an average degree of polymerization or number of monomers in a PVC chain) from about 55 to about 65, or about 60 (e.g., according to DIN 53726). The M-PVC and/or the S-PVC (e.g., in combination) may be present in the wear layer 16 in an amount from about 50 wt % to about 95 wt %, or about 65 wt %. The E-PVC may be present in the wear layer 16 in an amount from about 1 wt % to about 15 wt %, or about 5 wt %. In some examples, the inclusion of E-PVC in the PVC composition can promote faster fusion and/or can reduce a static electricity load during formation of the wear layer 16. The PVC copolymer can be or include, for example, a copolymer formed from vinyl chloride and vinyl acetate monomers. When included in the PVC composition, the PVC copolymer can improve a manufacturing process (e.g., including lamination and embossing) for the composite building material 10. Some examples of the wear layer 16 do not include the PVC copolymer. The PVC copolymer may be present in the wear layer 16 in an amount from about 0 wt % to about 40 wt %, or about 10 wt %. In some examples, the wear layer 16 can be or include single, homogeneous layer.

The PVC composition in the wear layer 16 can also include a stabilizer based on calcium (Ca) and zinc (Zn), such as a CaZn stabilizer (e.g., REAPAK B-NT/8106/3, available from REAGENS). In some implementations, the stabilizer is or includes a CaZn stabilizer and does not include any (or includes only trace amounts of) tin. For example, the wear layer 16 may not include a tin-based stabilizer, or may include less than about 0.00015 wt % of a tin-based stabilizer. Advantageously, the absence of tin-based stabilizers can make the PVC composition less harmful to health and the environment. Further, despite the absence of such stabilizers, the PVC composition can have properties (e.g., processability, transparency, etc.) that are superior or comparable to properties obtained when tin-based stabilizers are utilized. The stabilizer can be in solid (e.g., powder) or liquid form and may be present in the wear layer 16 in an amount from about 1 wt % to about 6 wt %, or about 3 wt %. In one example, the CaZn stabilizer can include Ca in an amount from about 0.5 wt % to about 0.9 wt % and/or can include Zn in an amount from about 5.0 wt % to about 6.2 wt %.

Additionally or alternatively, the PVC composition in the wear layer 16 can include an impact modifier. The impact modifier can be or include, for example, an acrylic clear impact modifier such as PARALOID HIA80 (available from the DOW CHEMICAL COMPANY) or CLEARSTRENGTH W300 (available from ARKEMA). The impact modifier can be used to achieve a desired impact resistance, reduce brittleness, and/or improve ultraviolet (UV) resistance of the wear layer 16. In some examples, the impact modifier can include an acrylic impact modifier, a CPE (chlorinated PE) impact modifier, and/or an MBS (methyl methacrylate butadiene styrene) impact modifier. Use of MBS can involve also using a UV absorber to prevent a yellowing effect caused by exposure of butadiene to UV radiation. The impact modifier may be present in the wear layer 16 in an amount from about 3 wt % to about 15 wt %, or about 10 wt %.

Additionally or alternatively, the PVC composition in the wear layer 16 can include an internal lubricant. The internal lubricant can be or include, for example, LOXIOL P1141 (glycerine-monooleate; available from EMERY OLEOCHEMICALS). The internal lubricant can influence processability and improve quality of the wear layer 16, for example, by reducing visible flow lines and/or reducing a yellowness index. The internal lubricant may be present in the wear layer 16 in an amount from about 0.5 wt % to about 3 wt %, or about 1 wt %.

Additionally or alternatively, the PVC composition in the wear layer 16 can include an external lubricant. The external lubricant can be or include, for example, LOXIOL P621 (complexester; available from EMERY OLEOCHEMICALS), PARALOID K175 (poly(methyl methacrylate); available from the DOW CHEMICAL COMPANY), or a combination thereof. The external lubricant can prevent the PVC composition from sticking to rollers used in a calendering process for manufacturing the wear layer 16, as described herein. The external lubricant may be present in the wear layer 16 in an amount from about 0.5 wt % to about 3 wt %, or about 1 wt %.

Additionally or alternatively, the PVC composition in the wear layer 16 can include a processing aid. The processing aid can be or include, for example, PARALOID K120 ND (poly(methyl methacrylate); available from the DOW CHEMICAL COMPANY). The processing aid can reduce or eliminate a presence of air in the wear layer 16. The processing aid may be present in the wear layer 16 in an amount from about 0.5 wt % to about 3 wt %, or about 2 wt %.

Additionally or alternatively, the PVC composition in the wear layer 16 can include a co-stabilizer. The co-stabilizer can be or include, for example, ESO (epoxidized soybean oil) and/or phosphite and can be included in the PVC composition to reduce the yellowness of the wear layer 16. The co-stabilizer may be present in the wear layer 16 in an amount from about 0.5 wt % to about 6 wt %, or about 3 wt %.

In various examples, the PVC composition in the wear layer 16 does not include any (or includes only trace amounts of) plasticizer, such as adipates, phthalates (e.g., DINP), terephthalates (e.g., DOTP), or DINCH. While other ingredients described herein (e.g., ESO or LOXIOL P1141) can be added to improve processability (e.g., reduce flow lines and/or thermal degradation) during formation of the wear layer 16, such ingredients do not act as plasticizers and/or have little or no influence on pliability, softness, flexibility, or durability of the wear layer 16. In some examples, the PVC composition may include plasticizer (e.g., adipates, phthalates (e.g., DINP), terephthalates (e.g., DOTP), or DINCH) in an amount less than about 0.1 wt %, less than about 0.01 wt %, less than about 0.001 wt %, or less than about 0.00015 wt %.

Table 1 lists various ingredients that may or may not be included in the wear layer 16, in accordance with certain examples. The table includes minimum, maximum, and typical values for the amount of each ingredient. Various embodiments include any value (e.g., any integer or real number) within the cited ranges. For example, an amount of PVC copolymer in the wear layer 16 can be greater than, less than (if applicable), and/or equal to 0, 1, 2, . . . , 39, or 40 wt %. Likewise, an amount of M-PVC and/or S-PVC in the wear layer 16 can be greater than, less than, and/or equal to 50, 51, 52, . . . , 94, or 95 wt %. In another example, an amount of E-PVC in the wear layer 16 can be greater than, less than, and/or equal to 1, 2, 3, . . . , 14, or 15 wt %. Express support and written description of these parameter values for each parameter are hereby represented.

TABLE 1
Composition of the wear layer 16.

| Component | Min. | Max. | Typical |
|---|---|---|---|
| M-PVC and/or S-PVC (wt %) | 50 | 95 | 65 |
| PVC-Copolymer (wt %) | 0 | 40 | 10 |
| E-PVC (wt %) | 1 | 15 | 5 |
| Acrylic impact modifier (wt %) | 3 | 15 | 10 |
| Internal lubricants (wt %) | 0.5 | 3 | 1 |
| External lubricants (wt %) | 0.5 | 3 | 1 |
| Processing aid (wt %) | 0.5 | 3 | 2 |
| Stabilizer (e.g., CaZn stabilizer) (wt %) | 1 | 6 | 3 |
| Co-stabilizer (e.g., ESO or phosphite) (wt %) | 0.5 | 6 | 3 |
| Plasticizer (wt %) | 0 | 0 | 0 |
| Tin-based stabilizer (wt %) | 0 | 0 | 0 |

Table 2 includes minimum, maximum, and typical values for certain properties of the wear layer 16. Various embodiments include any value (e.g., any integer or real number) within the cited ranges. For example, the Shore D hardness of the wear layer 16 can be 72, 73, . . . , 89, or 90. Express support and written description of these parameter values for each parameter are hereby represented. The UV stability values are on a blue wool scale (BWS), according to ISO 105-B02.

TABLE 2
Properties of the wear layer 16.

| Component | Min. | Max. | Typical |
|---|---|---|---|
| Hardness (Shore D) | 72 | 90 | 78 |
| Modulus of elasticity (MPa) | 1600 | 3000 | 2000 |
| UV stability (BWS) | 6 | 7 | 6-7 |
| Thickness (mm) | 0.1 | 1 | 0.3 to 0.7 |

As Table 2 indicates, the PVC composition in the wear layer 16 can be a rigid PVC composition. The rigid PVC composition and/or the wear layer 16 can have a Shore D hardness of at least about 72 and/or a modulus of elasticity of at least about 1600 MPa. By comparison, a flexible PVC can have a Shore A hardness from about 35 to about 90, and a semi-rigid PVC can have a Shore D hardness of about 65. The preceding values for hardness and modulus of elasticity can correspond to a temperature of about 23° C. and a relative humidity of about 50%.

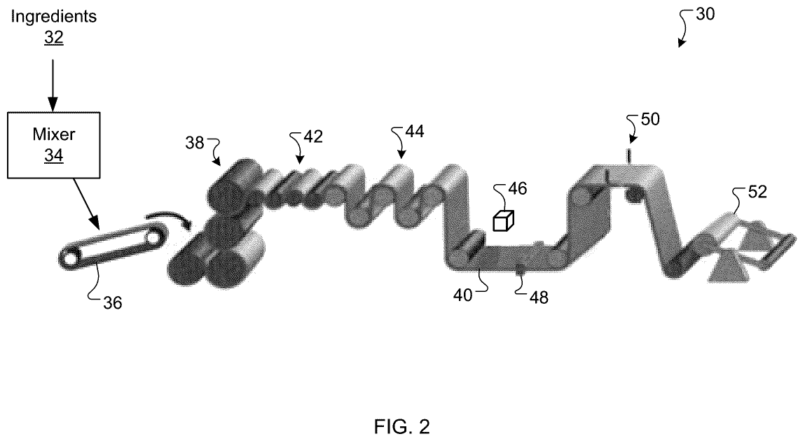

FIG. 2 is a schematic diagram of a manufacturing process 30 that can be used to manufacture a wear layer (e.g., the wear layer 16), in accordance with certain examples. A plurality of ingredients 32 (e.g., as shown in Table 1) are added to a heated mixer 34 (e.g., including a kneader) to form a melted PVC composition. An extruder, conveyor, or other delivery device 36 is used to apply the melted PVC composition to a set of calender rolls 38. The calender rolls 38 are heated (e.g., to a temperature of about 220° C.) and used to form a thin film or web 40 of the PVC composition. The web 40 is transported by a plurality of pull rolls 42 to a plurality of chill rolls 44, which cool the web 40 to a desired temperature (e.g., room temperature, or about 20-25° C.). A camera 46 can be used to scan a surface of the web 40 for quality control or defect detection. Likewise, a thickness measurement device 48 can be used to confirm the web 40 has a desired thickness. An edge-trimming device 50 can be used to trim edges of the web 40 and/or achieve a desired web width. The web 40 of wear layer material can be wound up into a roll 52.

In subsequent steps (not shown), the wear layer (e.g., web 38 or portions thereof) can be used to manufacture an LVT, an SPC, or other composite building material (e.g., the composite building material 10). For example, the web or portions thereof can be laminated or bonded to a printed layer (e.g., the printed layer 14), which can be laminated or bonded to a backing layer (e.g., the backing layer 12). The layers can be bonded together using adhesive and/or heat and pressure. The layers can be embossed with a decorative pattern, which can correspond to a color pattern in the printed layer. A coating or surface layer (e.g., the surface layer 18) can be applied to a top surface of the wear layer.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. For numerical ranges recited herein, various embodiments include any parameter value (e.g., integer or decimal value) within the cited ranges. For example, if a recited range is from 1 to 10, a value for the respective parameter can be greater than, less than, or equal to 1, 2, 3, . . . 9, or 10. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A wear layer comprising:
a PVC resin; and
a stabilizer comprising CaZn mixed with the PVC resin, wherein the wear layer comprises at least one of:
a Shore D hardness of at least about 72; or
a modulus of elasticity of at least about 1600 MPa.

2. The wear layer of claim 1, wherein the PVC resin comprises a blend of:
at least one of a first PVC resin produced by mass polymerization (M-PVC) or a second PVC resin produced by suspension polymerization (S-PVC); and
a third PVC resin produced by emulsion polymerization (E-PVC).

3. The wear layer of claim 2, wherein the PVC resin further comprises a PVC copolymer.

4. The wear layer of claim 1, wherein the wear layer is characterized by an absence of plasticizer.

5. The wear layer of claim 1, wherein the stabilizer is characterized by an absence of tin (Sn).

6. The wear layer of claim 1, wherein the stabilizer is characterized by an absence of barium (Ba).

7. The wear layer of claim 1, wherein the PVC resin and the stabilizer are mixed with an impact modifier, an internal lubricant, an external lubricant, a processing aid, and a co-stabilizer comprising at least one of epoxidized soybean oil (ESO) or phosphite.

8. The wear layer of claim 1, wherein the wear layer is transparent.

9. The wear layer of claim 1, wherein the wear layer is configured for use in a luxury vinyl tile or a stone plastic composite.

10. A composite building material comprising:
a wear layer comprising:
a PVC resin; and
a stabilizer comprising CaZn mixed with the PVC resin, wherein the wear layer comprises at least one of:
a Shore D hardness of at least about 72; or
a modulus of elasticity of at least about 1600 MPa.

11. The composite building material of claim 10, wherein the composite building material comprises a luxury vinyl tile or a stone plastic composite.

12. A method of manufacturing a wear layer, the method comprising:
providing a mixture of a PVC resin and a stabilizer comprising CaZn; and
forming the mixture into a web,
wherein the wear layer comprises at least one of:
a Shore D hardness of at least about 72; or
a modulus of elasticity of at least about 1600 MPa.

13. The method of claim 12, wherein forming the mixture into the web comprises:
melting the mixture; and
applying the mixture to a plurality of calender rollers.

14. The method of claim 12, further comprising winding the web into a roll.

15. A method of manufacturing a composite building material, the method comprising:
providing a wear layer comprising:
a PVC resin; and
a stabilizer comprising CaZn mixed with the PVC resin, wherein the wear layer comprises at least one of:
a Shore D hardness of at least about 72; or
a modulus of elasticity of at least about 1600 MPa; and
bonding the wear layer to at least one other layer.

16. The method of claim 15, wherein bonding the wear layer to the at least one other layer comprises laminating the wear layer onto a printed layer.

17. The method of claim 15, wherein the composite building material comprises at least one of a luxury vinyl tile or a stone plastic composite.
